(19) United States
(12) Patent Application Publication
(10) Pub. No.: US 2009/0268279 A1
(43) Pub. Date: Oct. 29, 2009

(54) REFLECTIVE MATERIAL AND REFLECTOR FOR LIGHT-EMITTING DIODE

(75) Inventor: Hiroyuki Higuchi, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Idemitsu Kosan Co, Ltd., Chiyoda-ku, Tokyo (JP)

(21) Appl. No.: 12/066,884

(22) PCT Filed: Sep. 1, 2006
(86) PCT No.: PCT/JP2006/317317

§ 371 Date: Mar. 14, 2008

(30) Foreign Application Priority Data
Sep. 29, 2005 (JP) 2005-159359
Jun. 8, 2006 (JP) 2006-159359

(51) Int. Cl. G02B 5/26; G02B 1/10; C08K 3/40; C08F 220/06

(52) U.S. Cl. 359/360; 359/359; 524/847; 526/318.5

(57) ABSTRACT

A reflective material which has a high UV light reflectance and maintains such a high reflectance even after heat treatment, and a reflector for LEDs are provided. A reflective material including a polymer obtained from a composition as a raw material which contains the following (a) and (b): (a) 95 to 30 mass % of a thermally polymerizable or photopolymerizable compound; and (b) 5 to 70 mass % of hollow particles which are formed of a material having an ultraviolet light transmittance of 50% or more at a wavelength of 350 nm.

### TECHNICAL FIELD

The invention relates to a reflective material and a reflector for a light-emitting diode.

### BACKGROUND

With the remarkable progress of light-emitting diodes (LED) since the 1990s, high-output, multi-color LEDs have been continuously developed. Of these LEDs, white LEDs are expected as the next-generation light source replacing conventional light sources such as white lamps, halogen lamps and HID lamps. In fact, LEDs are appreciated for their prolonged life, energy saving ability, temperature stability and low-voltage driving performance, and are therefore applied to displays, navigator panels, on-vehicle lamps, signal lamps, emergency lights, portable phones, video cameras, and the like. Such an emitting apparatus is normally produced by fixing an LED to a reflector formed of an integrated synthetic resin and lead frame, and sealing it with a sealing material such as an epoxy resin and a silicone resin.

A material for a reflector for LEDs is required to have a high light reflectance for efficient outcoupling of light emitted by an LED. Recently, an LED emitting UV light has come to be used. In response to such a trend, a material having a high UV light reflectance has been required. A reflective material for LEDs may often be exposed to high temperatures during sealing, soldering, or other steps. Therefore, it is required for a material for a reflector for LEDs to have a reflectance which is not lowered even when exposed to high temperatures.

A resin composition obtained by adding titanium oxide to a polyamide resin is widely used as a reflector for LEDs (see Patent Document 1, for example). This material exhibits a high reflectance in the visible region. However, since titanium oxide absorbs well UV light with a wavelength of 400 nm or less, the above-mentioned material which contains titanium oxide rarely reflects UV light with a wavelength of 400 nm or less. If fibrous potassium titanate is used instead of titanium oxide (Patent Document 2), UV light reflection properties are improved, but not sufficiently (reflectance: about 30% at 350 nm).

On the other hand, Patent Document 3 discloses a technique of providing a resin layer containing light-reflective fillers in the periphery of an emitting device when producing an LED lamp. As the light-reflective filler, a compound containing titanium and oxygen, such as titanium oxide and potassium titanate, is disclosed. However, these fillers have a property of absorbing UV light, and hence, exhibit an extremely low UV light reflectance.

Patent Document 4 discloses a light-reflective film in which a surface layer containing hollow particles is coated on a polyester resin sheet containing air bubbles. This film has a high light reflectance and enables luminance to improve when incorporated in liquid crystal backlight. However, no mention is made as to UV light reflection properties. For example, polyester is chosen since it has almost no absorption in the visible region. Since an LED lamp normally has a very small size of about 5 mm×5 mm×5 mm, it is difficult to incorporate the above stacked film into an LED lamp as a reflector. Furthermore, the document neither discloses nor studies a change in reflectance, which is important in the production of an LED lamp.

Patent Document 1: JP-A-2-288274

Patent Document 2: JP-A-2002-294070

Patent Document 3: JP-A-2000-150969

Patent Document 4: JP-A-2004-101601

An object of the invention is to provide a reflective material which has a high UV light reflectance and keeps such a high reflectance even after heat treatment, and a reflector for LEDs.

### SUMMARY OF THE INVENTION

According to the invention, the following reflective material and reflector for LEDs are provided.

1. A reflective material comprising a polymer obtained from a composition as a raw material which contains the following (a) and (b):

(a) 95 to 30 mass % of a thermally polymerizable or photopolymerizable compound; and

(b) 5 to 70 mass % of hollow particles which are formed of a material having an ultraviolet light transmittance of 50% or more at a wavelength of 350 nm.

2. The reflective material according to 1, wherein the thermally polymerizable or photopolymerizable compound has an ultraviolet light transmittance of 50% or more at a wavelength of 350 nm.
3. The reflective material according to 1 or 2, wherein the thermally polymerizable or photopolymerizable compound is one or two or more compounds selected from acrylic compounds, epoxy compounds, and silicone compounds.
4. The reflective material according to any one of 1 to 3, wherein the hollow particles comprise a cross-linked resin or an inorganic compound.
5. The reflective material according to any one of 1 to 4, wherein the hollow particles comprise a cross-linked styrene resin, a cross-linked acrylic resin, inorganic glass or silica.
6. The reflective material according to any one of 1 to 5 which further comprises a substrate having a visible light reflectance of 80% or more at a wavelength of 550 nm, the polymer obtained from the composition containing the (a) and (b) being coated on the substrate.
7. The reflective material according to 6, wherein the substrate comprises a resin composition containing a solid particle white pigment.
8. The reflective material according to 6, wherein the substrate comprises one or two or more metals selected from aluminum, gold, silver, copper, nickel, and palladium.
9. A reflector for a light-emitting diode comprising, at least on its reflective surface, the reflective material according to any one of 1 to 8.
10. The reflector for a light-emitting diode according to 9, wherein the reflective material is coated on a molded article comprising a resin composition containing a solid particle white pigment.
11. The reflector for a light-emitting diode according to 9, wherein the reflective material is coated on a molded article comprising one or two or more metals selected from aluminum, gold, silver, copper, nickel and palladium.

According to the invention, a reflective material having a high UV light reflectance and maintaining such a high UV light reflectance even after heat treatment and a reflector for LEDs can be provided.

### BRIEF DESCRIPTION OF DRAWINGS

FIG. 1 is graph showing the reflectance of a reflective board obtained in Example 2;

FIGS. 2a-2c are a view showing a reflector for an LED produced in Example 9, FIG. 2a is a cross-sectional view of a molded article obtained by subjecting a resin composition containing a solid particle white pigment to injection molding; FIG. 2b is a cross-sectional view of the molded article shown in FIG. 2a with an LED being installed and with a polymerized compound containing hollow particles being applied to the inside of the molded article; and FIG. 2c is a cross-sectional view of the molded article shown in FIG. 2b with a cured sealant filling the concave portion thereof.

### BEST MODE FOR CARRYING OUT THE INVENTION

The reflective material of the invention is formed from a polymer obtained from a composition as a raw material which contains a thermally polymerizable or photopolymerizable compound and hollow particles.

The thermally polymerizable compound or the photopolymerizable compound may be used either alone or as a mixture of two or more. The thermally polymerizable or photopolymerizable compound preferably has a UV light transmittance of 50% or more, more preferably 60% to 100%, to light having a wavelength of 350 nm in a thickness of 250 μm. Here, the UV light transmittance is a value obtained by measuring a resin which is polymerized by heat or light. If the UV light transmittance is high, the ratio of the UV light transmitting the resin layer and reaching the gas layer formed in the hollow particles becomes high. As a result, the ratio of the UV light reflected by this gas layer increases. A reflective material with a high UV light reflectance is thus formed.

As examples of the thermally polymerizable or photopolymerizable compound having a UV light transmittance of 50% or more at a wavelength of 350 nm when the thickness is 250 μm, acrylic compounds, epoxy compounds, silicone compounds, styrene compounds, phenol compounds, and unsaturated polyester compounds can be given. These compounds may be contained alone or in a mixture of two or more.

In the invention, the thermally polymerizable or photopolymerizable compound are defined as a compound which is polymerized by heat or light. Such compounds may be any of a monomer, an oligomer, and a resin. An oligomer or resin is further polymerized by the action of heat or light.

Of these, acrylic compounds, epoxy compounds and silicone compounds are preferable since these compounds provide a highly heat-resistant polymer. Acrylic compounds and silicone compounds are more preferable. Particularly preferable are (meth)acrylic ester compounds containing an alicyclic hydrocarbon group having 7 or more carbon atoms since these compounds provide a polymer which has a high glass transition temperature and is excellent in resistance to light.

As examples of the alicyclic hydrocarbon group, adamantyl, norbonyl, or dicyclopentanyl can be given. The thermally polymerizable or photopolymerizable compounds may be either a liquid or a solid before polymerization. For easy handling, it is more preferred that these compounds be liquid at room temperature.

A polymer (silicone resin) obtained from the silicone compound has a low glass transition temperature but is excellent in flexibility. Therefore, silicone resin can relax thermal stress generated during the production or use of an LED lamp, thereby reducing detachment of the sealant from the lead frame. In addition, silicone resins are excellent in resistance to light. Silicone resins are preferable for the above reasons.

The content of the thermally polymerizable or photopolymerizable compound is 95 to 30 mass %, preferably 90 to 50 weight % relative to the composition containing the thermally polymerizable or photopolymerizable compound and hollow particles.

The hollow particles are formed of a material having a UV light transmittance to light having a 350 nm wavelength of 50% or more, more preferably 60% to 100%, when the thickness is 250 μm. UV light which passes through the outer shell of the hollow particles is reflected at the hollow part. Therefore, it is required that the material constituting the hollow particles have a high UV light transmittance.

In order to increase the reflectance at the hollow part, it is preferred that a difference in refractive index between a portion constituting the hollow particle and a gas inside the hollow particle be large. Though the gas inside of the hollow particles is normally air, the gas may be an inert gas such as nitrogen and argon. The inside of the hollow particle may be vacuum.

It is preferred that the hollow particle be a particle having its inside one or more independent air bubbles. Alternatively, the hollow particle may be a secondary particle having a hollow part therein. The hollow particle may be formed of either an organic substance or an inorganic substance. If UV light is absorbed by the outer shell of the hollow particle, the amount of UV light reaching the inside of the hollow particle decreases, resulting in a lowered reflectance at the hollow part. Therefore, it is preferred that the hollow particles be formed of a material which does not absorb UV light well. The hollow part may be destroyed by heat treatment. It is preferred that the material constituting the hollow part be highly resistant to heat since the absence of the hollow part leads to the loss of reflection properties.

Preferable examples of such a material include inorganic substances such as metal oxides such as glass beads, silica and alumina, metal salts such as calcium carbonate, barium carbonate, calcium silicate and nickel carbonate and organic substances such as styrene resins, acrylic resins, and cross-linked substances of these resins. These materials may be contained singly or in combination of two or more. Of these, glass beads, silica, cross-linked acrylic resins, and cross-linked styrene resins are preferable.

Though there are no particular restrictions on the outer diameter of the hollow particles, the outer diameter is preferably 0.01 to 500 λm, more preferably 0.1 to 100 μm, in respect of light reflection properties and handling properties. If the outer diameter is smaller than 0.01 μm, the viscosity before polymerization of the composition containing the thermally polymerizable or photopolymerizable compound and hollow particles may increase, resulting in poor moldability. An outer diameter exceeding 500 μm may result in surface roughness of the reflector, causing the reflectance to be lowered.

Though there are no restrictions on the inner diameter of the hollow particles, in respect of light reflection properties, the inner diameter is preferably 0.005 to 100 μm, more preferably 0.1 to 50 μm. If the inner diameter is outside this range, reflection efficiency may be lowered.

The content of the hollow particles is 5 to 70 mass %, preferably 10 to 50 wt %, relative to the composition containing a thermally polymerizable or photopolymerizable compound and hollow particles. If the content is less than 5 wt %, reflectance may be lowered. When the content of the hollow particles exceeds 70 mass %, the viscosity before polymerization of the composition containing a thermally polymerizable or photopolymerizable compound and hollow particles may increase, resulting in poor moldability.

The polymer used in the reflective material of the invention may contain a thermoplastic resin to improve heat resistance. As for the thermoplastic resin, it is preferable to use a thermoplastic resin having a high degree of transparency and a glass transition temperature of 120° C. or more. If the glass transition temperature is lower than 120° C., the effect of improving heat resistance may be deteriorated. Normally, the thermoplastic resin is incorporated with the composition before polymerization.

Examples of the thermoplastic resin include acrylic resins, styrene resins, polycarbonates, polyarylesters, polyethersulfones, epoxyacrylates, olefin-maleimide copolymers, ZEONEX (cyclolefin-based polymer manufactured by Zeon Corporation), ZEONOR (cyclolefin-based polymer manufactured by Zeon Corporation), ARTON (cyclolefin-based polymer manufactured by JSR Corporation), TOPAS (cyclolefin-based polymer manufactured by Ticona, Inc.), transparent ABS, transparent propylenes, methacrylstyrene resins, polyarylates, polysulfones, transparent nylon, transparent polybutylene terephthalates, transparent fluorine resins, poly-4-methylpentene-1, and transparent phenoxy resins.

When the thermoplastic resin is added, it is preferred that the thermoplastic resin be added to the reflective material of the invention in an amount of 0.5 to 20 mass %. If the content is smaller than 0.5 mass %, the effect of improving the heat resistance may be insufficient. On the other hand, if the content exceeds 20 mass %, the composition before polymerization tends to have poor fluidity.

The polymer used in the reflective material of the invention may further contain a known antioxidant, a known photostabilizer, or the like. Examples of the antioxidant include phenol-based antioxidants, phosphor-based antioxidants, sulfur-based antioxidants, lactone-based antioxidants, and amine-based antioxidants.

The content of the antioxidant is normally 0.005 to 5 parts by mass, preferably 0.02 to 2 parts by mass to 100 parts by mass of the polymer. These additives may be used in combination of two or more.

As for the photostabilizer, a hindered amine-based photostabilizer may preferably be used.

The amount of the photostabilizer is normally 0.005 to 5 parts by mass, preferably 0.02 to 2 parts by mass to 100 parts by mass of the polymer. These additives may be used in combination of two or more.

For downsizing an emitting apparatus, it is preferred that a layer of the above polymer be thin. However, if the polymer layer is thick, reflectance increases since light is more likely to collide with hollow particles.

When forming a layer from the reflective material of the invention, the thickness of the polymer layer is preferably 0.05 to 2 mm, more preferably 0.25 to 2 mm.

The reflective material of the invention has remarkably high UV light reflectance. Furthermore, the reflective material of the invention maintains such a high reflectance even after heat treatment during the production of an emitting apparatus. The reflective material of the invention can maintain a reflectance of 50% or more to light having a wavelength of 350 nm even after harsh heat treatment such as sealing (at 100 to 200° C. for several hours) and reflow soldering (at 260° C. for several seconds).

The above polymer is used in a state in which a polymer layer is provided on a substrate formed of a material which preferably has a high visible light reflectance. As a result, a high reflectance can be obtained not only for UV light but also for visible light. Here, the expression “a material having a high visible light reflectance” means a material having a visible light reflectance of 80% or more at a wavelength of 550 nm.

As examples of a material for such a substrate, a resin composition containing a solid particle white pigment can be given. A substrate formed of a resin composition containing a solid particle white pigment such as titanium oxide has a low UV light reflectance, but has an extremely high visible light reflectance.

The polymer of the invention obtained from the composition is coated on the substrate formed of the resin composition. When the resulting coated body is irradiated with visible light from the top thereof, the light which passes, without being reflected, through the polymer layer obtained from the raw material composition is reflected by the substrate. That is, due to such a laminated configuration, high reflectance can be obtained not only for ultraviolet light but also for visible light.

As examples of the solid particle white pigment, titanium oxide, silica, potassium titanate, barium sulfate, alumina, zinc oxide, calcium carbonate, talc, mica, or the like can be given.

Though the content of the solid particle white pigment is not particularly restricted, the solid particle white pigment is contained preferably in an amount of 1 to 50 wt %, more preferably 5 to 40 wt %, to the resin composition containing the pigment.

As examples of the resin to which the solid particle white pigment is added, polyamide resins, liquid crystal polymers, polyether resins, syndiotactic polystyrenes, polyester resins, or the like, can be given.

Although there are no restrictions on the content of the resin to which the solid particle white pigment is added, the resin is contained preferably in an amount of 40 to 95 wt %, more preferably 50 to 90 wt %, relative to the amount of the resin composition containing the solid particle white pigment.

The resin composition containing the solid particle white pigment may also contain glass fibers or the like.

It is preferred that the substrate be formed of one or two or more metals selected from aluminum, gold, silver, copper, nickel and palladium. The substrate formed of such a metal can exhibit a high reflectance to UV light and visible light.

The substrate is not required to be flat, and may take any form.

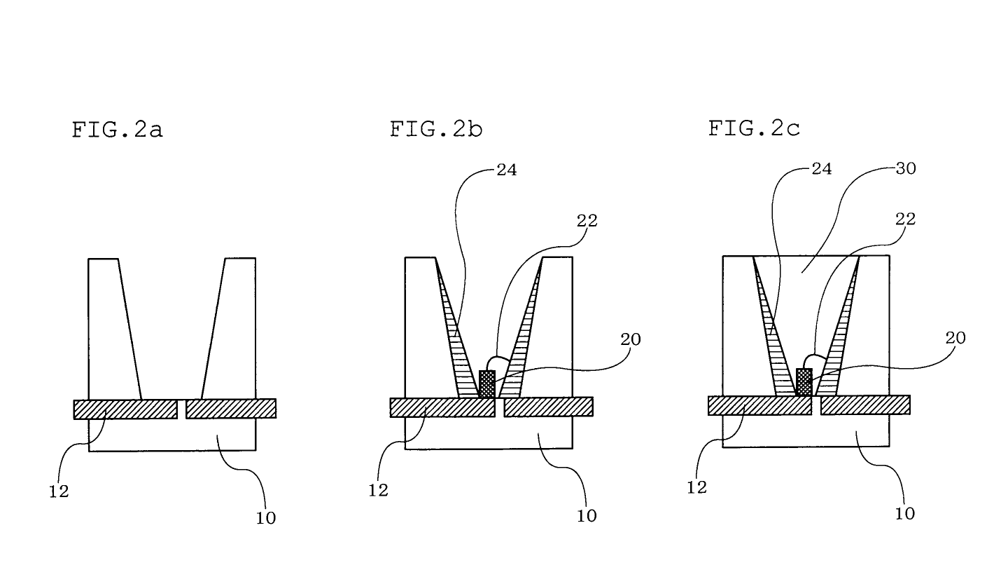

If the invention is applied to a reflector for LEDs, a substrate molded into a concave shape as shown by numeral 10 in FIG. 2a is used, for example. In this case, the thickness of the polymer layer formed of the composition containing a thermopolymerizable or photopolymerizable compound and hollow particles varies depending on the location (see numeral 24 in FIG. 2b). The maximum thickness of this layer is preferably 0.05 to 3 mm, more preferably 0.25 to 2 mm.

The reflective material of the invention can be produced by mixing hollow particles with a thermally polymerizable or photopolymerizable compound, followed by polymerization with heat or light. To promote the polymerization reaction, a polymerization initiator may be added. There are no particular restrictions on the kind of polymerization initiator. A radical polymerization initiator or the like may be used, for example. Examples of the radical polymerization initiator include ketone peroxides such as methyl ethyl ketone peroxide, methyl isobutyl ketone peroxide, acetyl acetone peroxide, cyclohexanone peroxide, and methylcyclohexanone peroxide; hydroperoxides such as 1,1,3,3-tetramethylbutyl hydroperoxide, cumen hydroperoxide, and t-butyl hydroperoxide; diacyl peroxide such as diisobutyryl peroxide, bis-3,5,5-trimethylhexanol peroxide, lauroyl peroxide, benzoyl peroxide, and m-tolylbenzoyl peroxide; dialkyl peroxides such as dicumyl peroxide, 2,5-dimethyl-2,5-di(t-butylperoxy)hexane, 1,3-bis(t-butylperoxyisopropyl)hexane, t-butylcumyl peroxide, di-t-butyl peroxide, and 2,5-dimethyl-2,5-di(t-butylperoxy)hexene; peroxy ketals such as 1,1-di(t-butylperoxy-3,5,5-trimethyl)cyclohexane, 1,1-di-t-butylperoxycyclohexane, and 2,2-di(t-butylperoxy)butane; alkylperesters such as 1,1,3,3-tetramethylbutylperoxycarbonate, α-cumylperoxyneodicarbonate, t-butylperoxyneodicarbonate, t-hexylperoxypivalate, t-butylperoxypivalate, 1,1,3,3-tetramethylbutylperoxy-2-ethylhexanoate, t-amylperoxy-2-ethylhexanoate, t-butylperoxy-2-ethylhexanoate, t-butylperoxyisobutylate, di-t-butylperoxyhexahydroterephthalate, 1,1,3,3-tetramethylbutylperoxy-3,5,5-trimethylhexanate, t-amylperoxy-3,5,5-trimethylhexanote, t-butylperoxy-3,5,5-trimethylhexanoate, t-butylperoxyacetate, t-butylperoxybenzoate, and dibutylperoxytrimethyladipate; and peroxycarbonates such as di-3-methoxybutylperoxydicarbonate, di-2-ethylhexylperoxydicarbonate, bis(1,1-butylcyclohexaoxydicarbonate), diisopropyloxydicarbonate, t-amylperoxyisopropylcarbonate, t-butylperoxyisopropylcarbonate, t-butylperoxy-2-ethylhexylcarbonate, and 1,6-bis(t-butylperoxycarboxy)hexane. Also, Perhexa 3M-95 (manufactured by NOF Corporation) and azobisisobutylonitrile which were used in Examples given later can also be used. The amount of the radical polymerization initiator is normally 0.01 to 5 parts by mass, preferably 0.05 to 1.0 part by mass, relative to 100 parts by mass of the thermopolymerizable or photopolymerizable compound. The above radical polymerization initiator may be used either alone or in combination of two or more.

The reflective material of the invention can be preferably used as a reflector for LEDs. However, it can be used for other reflective material applications. In particular, the reflective material of the invention can preferably be used in applications where reflection properties for UV light are required or applications where thermal stability is required.

The reflector for LEDs of the invention has, at least on its reflective surface, a layer of a polymer which is obtained from a composition as a raw material which contains a thermally polymerizable or a photopolymerizable compound and hollow particles.

In the reflector for LEDs of the invention, the polymer is preferably used in the state of being coated on a molded article (substrate) formed of a resin composition containing white solid particle pigment. Furthermore, in the reflector of the invention, the polymer is used in the state of being coated on a molded article (substrate) formed of a specific metal.

### EXAMPLES

The thermoplastic resin or other materials used in Examples and Comparative Examples are shown below.

### (1) Thermoplastic Resin

Semi-aromatic polyamide: Zytel HTN501 (manufactured by Dupont Japan)

### (2) Polymerizable Compound

### Acrylic Compound:

(a) Adamantate AM (1-adamantyl methacrylate manufactured by Idemitsu Kosan Co., Ltd)/Perhexa 3M-95 (NOF Corporation)=100/0.1 (mass ratio), UV light transmittance of the polymer=92% (wavelength: 350 nm, thickness: 250 μm)
(b) Fancryl FM-513 (dicyclopentanyl methacrylate manufactured by Hitachi Chemical Co., Ltd.)/azobisisobutylonitrile (Tokyo Kasei Industry Co., Ltd.)=100/0.1 (mass ratio), UV light transmittance of the polymer=92% (wavelength: 350 nm, thickness: 250 μm)
(c) Norbonyl methacrylate (Wako Pure Chemical Industries, Ltd.)/Peroxa 3M-95 (NOF Corporation)=100/0.1 (mass ratio), UV light transmittance of the polymer=92% (wavelength: 350 nm, thickness: 250 μm)

### Epoxy Compound:

Epikote 828 (manufactured by Japan Epoxy Resin Co., Ltd.)/methylhexahydrophthalic anhydride (curing agent, manufactured by Wako Pure Chemical Industries, Ltd.)/1,8-diazabicyclo[5,4,0]undec-7-en (manufactured by Sigma-Aldrich Corp)=50/50/0.1 (mass ratio), UV light transmittance of the polymer=90% (wavelength: 350 nm, thickness: 250 μm)

### Silicone Compound:

(a) XJL-0012A (manufactured by Nippon Pelnox Corporation)/XJL-0012B (manufactured by Nippon Pelnox Corporation)=100/5 (mass ratio), UV light transmittance of the polymer=93% (wavelength: 350 nm, thickness: 250 μm)
(b) SCR-1011A (manufactured by Shin-Etsu Silicone International Trading Co., Ltd.)/SCR-1011B (manufactured by Shin-Etsu Silicone International Trading Co., Ltd.)=100/100 (mass ratio), UV light transmittance of the polymer=91% (wavelength: 350 nm, thickness: 250 μm)

### (3) Hollow Filler (Hollow Particles)

Hollow glass beads: HSC-110C (manufactured by Potters-Ballotini Co., Ltd., average particle diameter: 13 μm, average pore diameter: 9 μm, (UV light transmittance of the glass=90% (wavelength: 350 nm, thickness: 250 μm))

Cross-linked acrylic hollow particles: XX06BZ (manufactured by Sekisui Plastics Co., Ltd., average particle diameter: 5 μm, average pore diameter: 1 to 2 μm, UV light transmittance of the cross-linked acrylic resin=84% (wavelength: 350 nm, thickness: 250 μm))

### (4) Solid Filler (Solid Particle White Pigment)

Silica beads: FB201SX (manufactured by Showa Denko K.K., average particle diameter: 7.8 μm)

Titanium oxide: Tipaque R680 (manufactured by Ishihara Sangyo Kaisha Ltd., average particle diameter: 0.21 μm)

### (5) Others

Glass fiber: JAFT164G manufactured by Asahi Fiber Glass Co., Ltd.

### Examples 1 to 5 and Comparative Examples 1 to 2

A filler was added to an acrylic compound (a) (liquid) in an amount ratio shown in Table 1. The acrylic compound (a) was irradiated for 15 minutes with an ultrasonic wave in an ultrasonic washer, thereby causing the filler to be sufficiently dispersed. 2 g of the filler dispersion was placed in an aluminum dish with a diameter of 5 cm, heat treated at 110° C. for 3 hours and 160° C. for 1 hour, whereby the acrylic compound (a) was thermally polymerized. After the polymerization, the resulting polymer was removed from the aluminum dish, whereby a round plate with a diameter of 5 cm and a thickness of about 1 mm was obtained. The round plate was subjected to the following treatment, and evaluated.

### (1) Heat Treatment

Heat treatment was conducted on the following two conditions. The following i) is a condition simulating thermal history applied to the reflective material during the sealing step, and ii) is a condition simulating thermal history applied to the reflective material during the reflow soldering step.

i) 160° C. for 3 hours
ii) 260° C. for 10 seconds

### (2) Irradiation of UV Light

Irradiation was conducted at 500 W/m² for 100 hours by means of a fadometer (solarbox1500e manufactured by JASCO International Co., Ltd.).

### (3) Measurement of Reflectance

The initial reflectance, the reflectance after heat treatment, and the reflectance after UV light irradiation were measured by the following method.

A multi-purpose large-sized sample unit (MPC-2200, manufactured by Shimadzu Corporation) was fixed to a microspectrophotometer (UV-2400PC, manufactured by Shimadzu Corporation). The reflectance (%) was measured within the wavelength range of 700 to 300 nm. Barium sulfate was used as a reference.

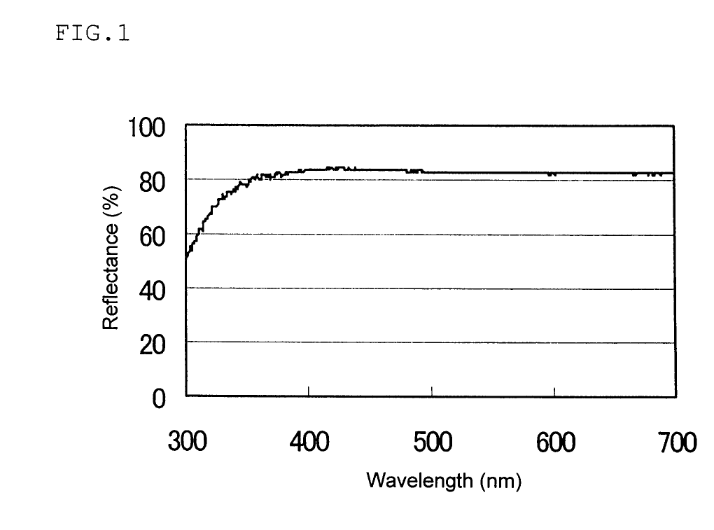

FIG. 1 shows the results of the measurement performed in Example 2. The reflectance at 550 nm and 350 nm is shown in Table 2.

### (4) Glass Transition Temperature

10 mg of sample was held at −50° C. for 5 minutes in the atmosphere of nitrogen and then the temperature was elevated at a rate of 20° C./min. A heat flow curve was obtained by means of a differential scanning calorimeter (DSC-7, manufactured by PerkinElmer, Inc.). The discontinuous point observed in the heat flow curve was taken as a glass transition temperature. The results are shown in Table 2.

### Example 6 and Comparative Example 3

A filler was added to an epoxy compound (liquid) in an amount ratio shown in Table 1. The epoxy compound was treated for 15 minutes with an ultrasonic wave in an ultrasonic washer, thereby causing the filler to be sufficiently dispersed. 2 g of the filler dispersion was placed in an aluminum dish with a diameter of 5 cm, heat treated at 130° C. for 3 hours, causing the epoxy compound to be thermally polymerized. As a result, a round plate with a diameter of 5 cm and a thickness of about 1 mm was obtained. The round plate was subjected to heat treatment or the like, and evaluated for the initial reflectance, the reflectance after heat treatment, and the reflectance after UV light irradiation in the same manner as in Example 1. Also, the glass transition temperature was measured by the method mentioned above. The results are shown in Table 2.

### Example 7

A filler was added to a silicone compound (a) (liquid) in an amount ratio shown in Table 1. The silicone compound (a) was treated for 15 minutes with an ultrasonic wave in an ultrasonic washer, thereby causing the filler to be sufficiently dispersed. 2 g of the filler dispersion was placed in an aluminum dish with a diameter of 5 cm, heat treated at 160° C. for 3 hours, causing the silicone compound (a) to be thermally polymerized. As a result, a round plate with a diameter of 5 cm and a thickness of about 1 mm was obtained. The round plate was subjected to heat treatment or the like, and evaluated for the initial reflectance, the reflectance after heat treatment, and the reflectance after UV light irradiation in the same manner as in Example 1. The results are shown in Table 2.

### Comparative Example 4

A semi-aromatic polyamide, titanium oxide, and glass fibers were compounded in an amount ratio shown in Table 1, and subjected to dry blending. The resulting blend was put to a hopper of a twin extruder with an inner diameter of 30 mm, melt kneaded at a barrel temperature of 330° C., whereby pellets were obtained. The resulting pellets were dried at 100° C. for a whole day and night, subjected to injection molding at a barrel temperature of 330° C. and a mold temperature of 120° C., whereby a 3 cm×3 cm square plate with a thickness of 1 mm was obtained. The square plate was subjected to heat treatment or the like, and evaluated for the initial reflectance, the reflectance after heat treatment, and the reflectance after UV light irradiation in the same manner as in Example 1. The results are shown in Table 2.

TABLE 1

| Raw | | | | | | | | | | | |
|---|---|---|---|---|---|---|---|---|---|---|---|
| material | | | | | | | | Com. | Com. | Com. | Com. |
| (wt %) | Example 1 | Example 2 | Example 3 | Example 4 | Example 5 | Example 6 | Example 7 | Ex. 1 | Ex. 2 | Ex. 3 | Ex. 4 |
| Acrylic | 90 | 80 | 70 | 50 | 80 | | | 80 | 80 | | |
| compound | | | | | | | | | | | |
| (a) | | | | | | | | | | | |
| Epoxy | | | | | | 80 | | | | 80 | |
| compound | | | | | | | | | | | |
| Silicone | | | | | | | 80 | | | | |
| compound | | | | | | | | | | | |
| (a) | | | | | | | | | | | |
| Semi- | | | | | | | | | | | 70 |
| aromatic | | | | | | | | | | | |
| polyamide | | | | | | | | | | | |
| Hollow | 10 | 20 | 30 | 50 | | 20 | 20 | | | | |
| glass | | | | | | | | | | | |
| beads | | | | | | | | | | | |
| Cross- | | | | | 20 | | | | | | |
| linked | | | | | | | | | | | |
| acrylic | | | | | | | | | | | |
| hollow | | | | | | | | | | | |
| particles | | | | | | | | | | | |
| Solid | | | | | | | | 20 | | | |
| silica | | | | | | | | | | | |
| beads | | | | | | | | | | | |
| Titanium | | | | | | | | | 20 | 20 | 10 |
| oxide | | | | | | | | | | | |
| Glass | | | | | | | | | | | 20 |
| fibers | | | | | | | | | | | |

### Example 8

1 g of a filler dispersion, used in Example 2, which was obtained by dispersing the hollow glass beads in an acrylic compound (a) was applied to the square plate obtained in Comparative Example 4 (visible light reflectance of 90.6% at 550 nm), followed by thermal polymerization at 110° C. for 3 hours and 160° C. for 1 hour. The square plate was subjected to heat treatment or the like, and evaluated for the initial reflectance, the reflectance after heat treatment, and the reflectance after UV light irradiation in the same manner as in Example 1. The results are shown in Table 2.

### Comparative Example 5

A light-reflective film with a thickness of about 200 μm was prepared according to the method described in Example 1 of JP-A-2004-101601.

Specifically, pellets obtained by mixing 89 wt % of polyethylene terephthalate (hereinafter referred to as PET) with an intrinsic viscosity of 0.63 dl/g and a melting point of 256° C., 10 wt % of polymethylpentene with a melting point of 235° C., and 1 wt % of polyethylene glycol with a molecular weight of 4,000 were supplied to a main extruder. Pellets obtained by mixing 85 wt % of PET and 15 wt % of calcium carbonate particles with an average particle size of 1.5 μm were supplied to a sub-extruder. Melt kneading was performed such that the component supplied to the sub-extruder was laminated on the both surfaces of a resin layer extruded from the main extruder, and cooled on a mirror-finished casting drum according to the electrostatic application method, whereby a three-layered sheet was prepared. The layered sheet was elongated at 90° C. such that the size was increased 3.3 times in the longitudinal direction. Subsequently, the sheet was preheated at 110° C. in the preheating zone of a tenter, and then elongated at 120° C. such that the size was increased 3.5 times in the width direction. The resulting elongated sheet was heat treated at 220° C. for 30 seconds, whereby an elongated heat-treated sheet was obtained. The coating material mentioned below was applied to one surface of the sheet such that the average thickness of the coating material after drying became 10 μm, and dried at 120° C. for 2 minutes, whereby a light reflective film with a total film thickness of 200 μm was obtained. The coating material was prepared by adding 2 parts (part by weight; the same can be applied hereinafter) of a solution of a modified styrene-butadiene aqueous binder and pigment (concentration of solid matter: 50%) (Nipol LX407BP, manufactured by Zeon Corporation) to 1 part of an emulsion solution (concentration of solid matter: 33%) obtained by finely dispersing in water hollow silica particles B-6C with an average particle size of 2 μm (manufactured by Suzuki Yushi Co., Ltd.), followed by stirring. For the resulting light reflective film, the average oval air bubble content was 92.8% and the ratio of area occupied by the hollow particles was 60.9%. Though this film had oval air bubbles, the reflective material of Examples did not contain oval air bubbles.

The resulting film was subjected to heat treatment or the like, and evaluated for the initial reflectance, the reflectance after heat treatment, and the reflectance after UV light irradiation in the same manner as in Example 1. The results are shown in Table 2.

TABLE 2

| | | Reflectance (%) | | | | | | | | | | | | |
|---|---|---|---|---|---|---|---|---|---|---|---|---|---|---|
| Wavelength | Treatment | | | | | | | | Com. | Com. | Com. | Com. | | Com. |
| (nm) | condition | Ex. 1 | Ex. 2 | Ex. 3 | Ex. 4 | Ex. 5 | Ex. 6 | Ex. 7 | Ex. 1 | Ex. 2 | Ex. 3 | Ex. 4 | Ex. 8 | Ex. 5 |
| 350 | None | 54.6 | 77.3 | 79.9 | 84.7 | 66.7 | 75.7 | 78.1 | 24.6 | 1.3 | 1.1 | 4.0 | 78.0 | 73.5 |
| 350 | 160° C. | 50.2 | 66.4 | 69.8 | 78.2 | 56.1 | 65.3 | 76.4 | 22.7 | 1.1 | 1.0 | 2.7 | 66.9 | 20.2 |
| | 3 h | | | | | | | | | | | | | |
| 350 | 260° C. | 54.5 | 76.0 | 79.6 | 83.6 | 67.5 | 72.9 | 78.0 | 24.0 | 1.3 | 1.2 | 4.0 | 77.4 | 65.1 |
| | 10 s | | | | | | | | | | | | | |
| 350 | UV | 54.3 | 77.0 | 79.5 | 84.1 | 66.7 | 52.4 | 77.9 | 24.4 | 1.2 | 1.1 | 3.9 | 76.3 | 48.8 |
| | 100 h | | | | | | | | | | | | | |
| 550 | None | 58.3 | 81.9 | 85.8 | 89.9 | 83.5 | 81.6 | 83.5 | 24.9 | 97.2 | 96.8 | 90.6 | 90.4 | 96.6 |
| 550 | 160° C. | 58.4 | 81.8 | 85.7 | 89.1 | 84.6 | 78.0 | 83.7 | 24.6 | 96.9 | 91.7 | 87.4 | 87.0 | 90.8 |
| | 3 h | | | | | | | | | | | | | |
| 550 | 260° C. | 58.0 | 81.9 | 85.8 | 89.3 | 85.3 | 79.9 | 83.5 | 25.0 | 97.0 | 92.6 | 90.4 | 90.1 | 95.9 |
| | 10 s | | | | | | | | | | | | | |
| 550 | UV | 58.4 | 81.9 | 85.6 | 90.0 | 83.7 | 78.1 | 83.4 | 25.1 | 97.3 | 92.2 | 87.8 | 87.4 | 90.3 |
| | 100 h | | | | | | | | | | | | | |

| | | | | | | | | | | | | | |
|---|---|---|---|---|---|---|---|---|---|---|---|---|---|
| Glass transition | 200 | 200 | 200 | 200 | 200 | 122 | — | 200 | 200 | 122 | — | — | — |
| temperature (° C.) | | | | | | | | | | | | | |

### Example 9

An electronic component (reflector for LEDs) shown in FIG. 2c was prepared.

The resin composition 10 used in Comparative Example 4 was subjected to injection molding (barrel temperature: 330° C., mold temperature: 120° C.), thereby to obtain an article integrated with a lead frame 12 as shown in FIG. 2a. An emitting element 20 (NCCU033, manufactured by Nichia Corporation) was fixed to this molded article. After bonding of a gold wire 22, a filler dispersion 24, used in Example 2, which was obtained by dispersing hollow glass beads in an acrylic compound (a) was applied to the inside of the injection molded article (see FIG. 2b), followed by thermal polymerization at 110° C. for 3 hours and at 160° C. for 1 hour. The maximum thickness of the thermally polymerized product 24 was about 0.7 mm. Subsequently, an acrylic compound (a) was put to the concave part of the molded article as a sealant 30, followed by polymerization at 110° C. for 3 hours and at 160° C. for 1 hour (see FIG. 2c) The resulting electronic product was energized, and the luminance was visually checked. Evaluation was conducted according to the following criteria:

Very good: Very bright

Good: Bright

Poor: Not bright

Very poor: Dark

Table 3 shows the results of the evaluation.

### Example 10

An electronic product was obtained in the same manner as in Example 9, except that the silicone compound (a) was used instead of the acrylic compound (a), and the thermal polymerization was performed at 160° C. for 3 hours. The resulting electronic product was energized, and the luminance was visually checked. Table 3 shows the results of the evaluation.

### Comparative Example 6

An electronic product was obtained in the same manner as in Example 9, except that the dispersion used in Comparative Example 2 which was obtained by dispersing titanium oxide in an acrylic compound (a) instead of the filler dispersion used in Example 2 which was obtained by dispersing the hollow glass beads in an acrylic compound (a). The resulting electronic product was energized, and the luminance was visually checked. Table 3 shows the results of the evaluation.

TABLE 3

| | Molded | | | |
|---|---|---|---|---|
| | article | Polymer | | |
| | (substrate) | layer | Sealant | Luminance |
| Example 9 | Comparative | Example 2 | Acrylic | Very good |
| | Example 4 | | compound (a) | |
| Example 10 | Comparative | Example 2 | Silicone | Very good |
| | Example 4 | | compound (a) | |
| Comparative | Comparative | Comparative | Acrylic | Good |
| Example 6 | Example 4 | Example 2 | compound (a) | |

### Example 11

A filler (hollow particles) was added to an acrylic compound (b) in an amount ratio shown in Table 4. The acrylic compound (b) was treated for 15 minutes with an ultrasonic wave in an ultrasonic washer, thereby causing the filler to be sufficiently dispersed. 2 g of the filler dispersion was placed in an aluminum dish with a diameter of 5 cm, heat treated at 110° C. for 3 hours and 160° C. for 1 hour, causing the acrylic compound (b) to be thermally polymerized. As a result, a round plate with a diameter of 5 cm and a thickness of about 1 mm was obtained.

The plate was subjected to heat treatment or the like, and evaluated for the initial reflectance, the reflectance after heat treatment, and the reflectance after UV light irradiation in the same manner as in Example 1. Also, the glass transition temperature was measured by the method mentioned above. The results are shown in Table 5.

### Example 12

A filler (hollow particles) was added to an acrylic compound (c) in an amount ratio shown in Table 4. The acrylic compound (c) was treated for 15 minutes with an ultrasonic wave in an ultrasonic washer, thereby causing the filler to be sufficiently dispersed. 2 g of the filler dispersion was placed in an aluminum dish with a diameter of 5 cm, heat treated at 110° C. for 3 hours and 160° C. for 1 hour, causing the acrylic compound (c) to be thermally polymerized. As a result, a round plate with a diameter of 5 cm and a thickness of about 1 mm was obtained.

The plate was subjected to heat treatment or the like, and evaluated for the initial reflectance, the reflectance after heat treatment, and the reflectance after UV light irradiation in the same manner as in Example 1. Also, the glass transition temperature was measured by the method mentioned above. The results are shown in Table 5.

### Example 13

A filler (hollow particles) was added to a silicone compound (b) in an amount ratio shown in Table 4. The silicone compound (b) was treated for 15 minutes with an ultrasonic wave in an ultrasonic washer, thereby causing the filler to be sufficiently dispersed. 2 g of the filler dispersion was placed in an aluminum dish with a diameter of 5 cm, heat treated at 70° C. for 1 hour and 150° C. for 5 hours, whereby the silicone compound (b) was thermally polymerized. As a result, a round plate with a diameter of 5 cm and a thickness of about 1 mm was obtained.

The plate was subjected to heat treatment or the like, and evaluated for the initial reflectance, the reflectance after heat treatment, and the reflectance after UV light irradiation in the same manner as in Example 1. Also, the glass transition temperature was measured by the method mentioned above. The results are shown in Table 5.

### Example 14

0.7 g of the filler dispersion prepared in Example 3 was placed in an aluminum dish with a diameter of 5 cm, and subjected to heat treatment at 110° C. for 3 hours and 160° C. for 1 hour, whereby a round plate-like polymer product with a diameter of 5 cm and a thickness of 0.3 mm was obtained.

The product was subjected to heat treatment or the like, and evaluated for the initial reflectance, the reflectance after heat treatment, and the reflectance after UV light irradiation in the same manner as in Example 1. Also, the glass transition temperature was measured by the method mentioned above. The results are shown in Table 5.

### Example 15

0.25 g of the filler dispersion prepared in Example 3 was placed in an aluminum dish with a diameter of 5 cm, and subjected to heat treatment at 110° C. for 3 hours and 160° C. for one hour, whereby a round plate-like polymer product with a diameter of 5 cm and a thickness of 0.1 mm was obtained.

The product was subjected to heat treatment or the like, and evaluated for the initial reflectance, the reflectance after heat treatment, and the reflectance after UV light irradiation in the same manner as in Example 1. Also, the glass transition temperature was measured by the method mentioned above. The results are shown in Table 5.

### Example 16

1 g of the filler dispersion prepared in Example 3 was applied to a 3 cm×3 cm silver-plated aluminum plate with a thickness of 1 mm, and thermally polymerized at 110° C. for 3 hours and 160° C. for 1 hour. After the polymerization, the polymer layer was evaluated without removing from the aluminum plate.

The resulting product was subjected to heat treatment or the like, and evaluated for the initial reflectance, the reflectance after heat treatment, and the reflectance after UV light irradiation in the same manner as in Example 1. The results are shown in Table 5. The light reflectance of silver at 550 nm is 98%.

TABLE 4

| Raw | | | | | | |
|---|---|---|---|---|---|---|
| material | Exam- | Exam- | Exam- | Exam- | Example | Example |
| (wt %) | ple 11 | ple 12 | ple 13 | ple 14 | 15 | 16 |
| Acrylic | | | | 70 | 70 | 70 |
| compound | | | | | | |
| (a) | | | | | | |
| Acrylic | 70 | | | | | |
| compound | | | | | | |
| (b) | | | | | | |
| Acrylic | | 70 | | | | |
| compound | | | | | | |
| (c) | | | | | | |
| Silicone | | | 70 | | | |
| compound | | | | | | |
| (b) | | | | | | |
| Hollow | | | | 30 | 30 | 30 |
| glass | | | | | | |
| beads | | | | | | |
| Cross- | 30 | 30 | 30 | | | |
| linked | | | | | | |
| acrylic | | | | | | |
| hollow | | | | | | |
| particles | | | | | | |

TABLE 5

| | | Reflectance (%) | | | | | |
|---|---|---|---|---|---|---|---|
| Wavelength | Treatment | Example | Example | Example | Example | Example | Example |
| (nm) | condition | 11 | 12 | 13 | 14 | 15 | 16 |
| 350 | None | 76.9 | 78.4 | 77.4 | 74.5 | 64.0 | 84.8 |
| 350 | 160° C. | 70.0 | 69.6 | 68.9 | 67.1 | 59.5 | 83.5 |
| | 3 h | | | | | | |
| 350 | 260° C. | 76.2 | 78.3 | 77.5 | 74.0 | 63.9 | 84.4 |
| | 10 s | | | | | | |
| 350 | UV | 76.5 | 78.0 | 77.2 | 74.3 | 63.5 | 84.0 |
| | 100 h | | | | | | |
| 550 | None | 80.1 | 80.4 | 79.9 | 77.6 | 66.5 | 94.1 |
| 550 | 160° C. | 79.3 | 79.5 | 78.4 | 76.2 | 65.0 | 93.5 |
| | 3 h | | | | | | |
| 550 | 260° C. | 80.2 | 80.1 | 79.5 | 77.4 | 66.4 | 94.2 |
| | 10 s | | | | | | |
| 550 | UV | 80.1 | 80.2 | 80.0 | 77.1 | 66.0 | 93.6 |
| | 100 h | | | | | | |

| | | | | | | |
|---|---|---|---|---|---|---|
| Glass transition | 155 | 172 | 40 | 200 | 200 | — |
| temperature (° C.) | | | | | | |

### INDUSTRIAL APPLICABILITY

The reflective material of the invention can be used for lamp reflectors for liquid crystal displays, reflective boards for showcases, reflective boards for various illuminators, reflectors for LEDs or the like. Reflectors for LEDs can be used for various OA apparatuses, electric and electronic devices and components, and automobile components such as displays, navigator panels, on-vehicle lamps, signal lamps, emergency lamps, portable phones, and video cameras.

1-11. (canceled)

12: A reflective material comprising a polymer obtained from a composition as a raw material which contains the following (a) and (b):
(a) 95 to 30 mass % of a thermally polymerizable or photopolymerizable compound; and
(b) 5 to 70 mass % of hollow particles which are formed of a material having an ultraviolet light transmittance of 50% or more at a wavelength of 350 nm.

13: The reflective material according to claim 12, wherein the thermally polymerizable or photopolymerizable compound has an ultraviolet light transmittance of 50% or more at a wavelength of 350 nm.

14: The reflective material according to claim 12, wherein the thermally polymerizable or photopolymerizable compound is one or two or more compounds selected from acrylic compounds, epoxy compounds, and silicone compounds.

15: The reflective material according to claim 12, wherein the hollow particles comprise a cross-linked resin or an inorganic compound.

16: The reflective material according to claim 12, wherein the hollow particles comprise a cross-linked styrene resin, a cross-linked acrylic resin, inorganic glass or silica.

17: The reflective material according to-claim 12 which further comprises a substrate having a visible light reflectance of 80% or more at a wavelength of 550 nm, and the polymer obtained from the composition containing the (a) and (b) being coated on the substrate.

18: The reflective material according to claim 17, wherein the substrate comprises a resin composition containing a solid particle white pigment.

19: The reflective material according to claim 17, wherein the substrate comprises one or two or more metals selected from aluminum, gold, silver, copper, nickel, and palladium.

20: A reflector for a light-emitting diode comprising, at least on its reflective surface, the reflective material according to claim 12.

21: The reflector for a light-emitting diode according to claim 20, wherein the reflective material is coated on a molded article comprising a resin composition containing a solid particle white pigment.

22: The reflector for a light-emitting diode according to claim 20, wherein the reflective material is coated on a molded article comprising one or two or more metals selected from aluminum, gold, silver, copper, nickel and palladium.
